(19) United States
(12) Patent Application Publication
(10) Pub. No.: US 2013/0198528 A1
(43) Pub. Date: Aug. 1, 2013

(54) Modifying a Length of an Element to Form an Encryption Key

(71) Applicant: Craig A. Walrath, Spring, TX (US)

(72) Inventor: Craig A. Walrath, Spring, TX (US)

(21) Appl. No.: 13/877,129

(22) PCT Filed: Oct. 5, 2010
(86) PCT No.: PCT/US2010/051411

§ 371 Date: Mar. 29, 2013

(51) Int. Cl. G06F 21/60

(52) U.S. Cl. CPC G06F 21/602
USPC 713/189

(57) ABSTRACT

A length of an element used as part of an encryption key for encrypting data is modified. Data is encrypted using the encryption key, and the encrypted data is provided for storing in a storage device (106, 204).

### BACKGROUND

An electronic device typically includes a storage device to store data. The storage device can be a volatile memory device used to temporarily store various types of data, including user or application data, machine-readable instructions, and so forth. Alternatively, the storage device can be a persistent storage device such as a disk-based storage device or a non-volatile, memory device. The data stored in a storage device can include sensitive or confidential data, such as security keys, user credentials, financial information, personal information, and so forth. If the electronic device is stolen or otherwise accessed in an unauthorized manner, a hacker may attempt to retrieve the content of the storage device to obtain sensitive or confidential information stored in the storage device.

### BRIEF DESCRIPTION OF THE DRAWINGS

Some embodiments are described with respect to the following figures:

FIGS. 1 and 2 are block diagrams of example arrangements incorporating some implementations; and

FIG. 3 is a flow diagram of a process of protecting content of a storage device, according to some implementations.

### DETAILED DESCRIPTION

In accordance with some implementations, techniques or mechanisms are provided to protect content of a storage device in an electronic device, which can be a computer, personal digital assistant, electronic appliance, storage server, mobile telephone, or other type of electronic device. In some examples, the storage device can be a volatile memory device implemented with dynamic random access memory (DRAM) or static random access memory (SRAM) technology. In alternative examples, the storage device can be a non-volatile memory device such as a flash memory device. As yet further examples, the storage device can be a disk-based storage device, such as a hard disk drive or optical disk drive. In other examples, other types of storage devices can be used.

As part of a protection mechanism or technique, a data key is used along with an encryption technique to encrypt data to be stored in the storage device. There can be times when the data key generated is not the same length as the data or information segments being encrypted; as a result, the length of the data key would have to be modified appropriately to form an encryption key to apply encryption on the data or information segment. Also, there can be times when a data key is mixed with another information element—to allow the mixing to be performed correctly, the length of the encryption key and/or other information element to be mixed with the encryption key may have to be modified.

Data protection techniques or mechanisms according to some implementations are able to produce an encryption key (for encrypting data to be stored in a storage device) by modifying a length of an element used to form tie encryption key. The element whose length is modified can be a data key and/or address information used in forming the encryption key. Modifying the length of the element includes increasing or decreasing its length. Various techniques for modifying the length of the element are discussed further below.

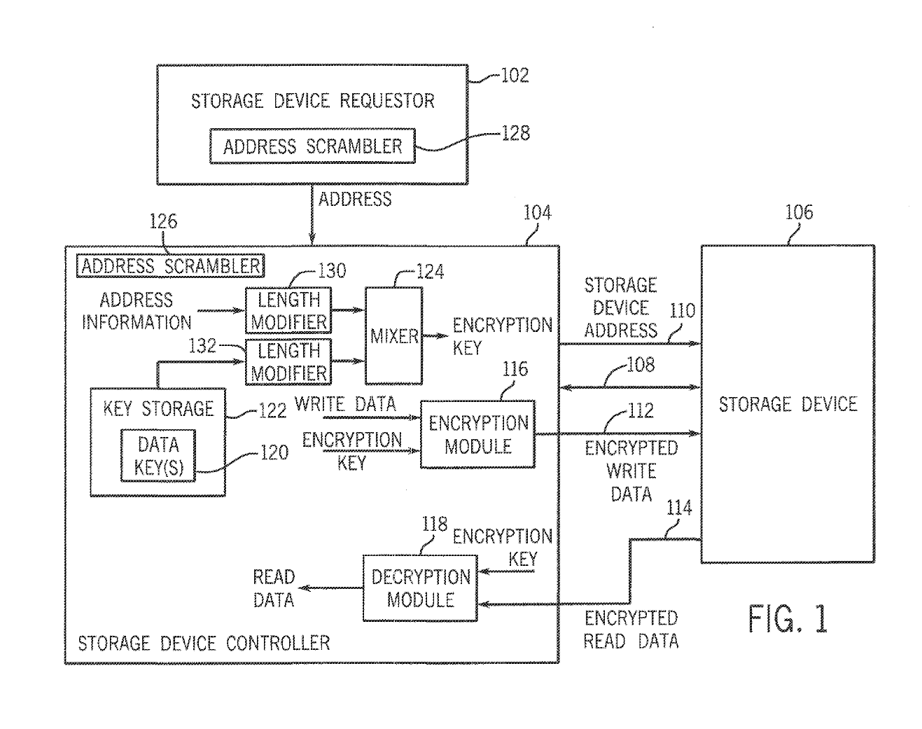

FIG. 1 depicts an example arrangement that includes a storage device requestor 102, a storage device controller 104 (provided with data protection mechanisms according to some implementations), and a storage device 106. The storage device requestor 102 is able to access (read or write) the content of the storage device 106 through the storage device controller 104. Examples of the storage device requestor 102 include a processor, an input/output (I/O) controller, or other type of requestor.

A storage device bus 108 interconnects the storage device controller 104 and storage device 106. The storage device bus 108 includes a control portion (for carrying control signals), an address portion (for carrying address signals), and a data portion (for carrying data read from or written to the storage device 106). The control, address, and data portions of the bus 108 are shown separately as an example. Various implementations could have these as separate connections, but the portions can also be multiplexed or sent on common bus signals, and so forth. Also, the control, address, and/or data portions can be implemented as wired or wireless connections. In wireless implementations, the control, address, and/or data portions are transmitted using a wireless protocol.

As shown in FIG. 1, the storage device controller 104 can provide a storage device address 110 to access a location of the storage device 106. For a write operation, write data 112 can be provided to the storage device 106, and for a read operation, read data 114 can be retrieved from the storage device 106. To protect content of the storage device 106, write data 112 sent to the storage device 106 from the storage device controller 104 includes encrypted write data. If data is read from a location of the storage device 106 that is protected by encryption, the corresponding read data 114 is encrypted read data.

For further protection of the content of the storage device 106, the storage device address 110 can be a scrambled address (in which an initial address is modified by application of a scrambling technique, discussed further below). Scrambling of an address can be performed using either an address scrambler 126 in the storage device controller 104, or an address scrambler 128 in the storage device requestor 102.

Note that not all locations in the storage device 106 have to be protected by data encryption and address scrambling—in some examples, certain locations of the storage device 106 are not subject to data encryption and/or address scrambling. For example, data encryption and/or address scrambling can be selectively enabled or disabled for specific storage locations. The selective enabling/disabling of data encryption and/or address scrambling can be accomplished by including a command field with a storage access command to specify whether or not the corresponding storage location is to be protected by data encryption and/or address scrambling. Alternatively, other mechanisms can be used for selectively enabling/disabling data encryption and/or address scrambling for specific storage locations, such as by use of configuration information, an application programming interlace (API), and so forth.

Using both address scrambling and data encryption provides an enhanced level of protection for data stored in the storage device 106. In this way, the likelihood of a hacker being able to retrieve content of protected data in the storage device is reduced. In trying to retrieve data from the storage device 106, the hacker may steal the electronic device, remove the storage device 106 from the electronic device, or otherwise gain unauthorized access to the storage device 106 (either physically or electronically).

Although FIG. 1 shows just one storage device controller 104 implemented with data protection mechanisms to protect data in the storage device 106, note that there can be additional storage device controller(s) with similar data protection mechanisms for other storage device(s).

The storage device controller 104 includes an encryption module 116 to encrypt (un-encrypted) write data, and a decryption module 118 to decrypt encrypted read data 114. The decryption module 118 outputs decrypted read data.

Each of the encryption module 116 and decryption module 118 is supplied with an encryption key to perform the respective encryption or decryption. The encryption key can be based on a data key 120 stored in key storage 122. Alternatively, the data key provided to the encryption module 116 and decryption module 118 can be a mixed key output by a key mixer 124. The key mixer 124 mixes a data key 120 from the key storage 122 with address information to output the mixed key. The mixing of the data key with the address information can be an exclusive-OR of the data key and the address information. Other types of mixing of the data key and address information can be used in other implementations. Note the key mixer 124 can be omitted in implementations that do not mix data keys and address information to form encryption keys.

As noted above, in accordance with some implementations, length modification can be performed on element(s) used for forming an encryption key. In FIG. 1, length modification can be performed by a length modifier 130 (for modifying a length of address information) or a length modifier 132 (for modifying a length of a data key 120). In some implementations, just one of the length modifiers 130 and 132 is present. In other implementations, both length modifiers 130 and 132 are present. Length modification can also alternatively be accomplished by mixing a data key 120 with address information by the mixer 124 (in which case the length modifiers 130 and 132 can be omitted).

As noted above, there may be times when a data key 120 is not the same length as the data or information segment being encrypted; as a result, the length of the data key would have to be modified appropriately. Also, there may be times when a data key is mixed with another information element (e.g, address information)—to allow the mixing to be performed correctly, the length of the data key and/or address information to be mixed with the data key may have to be modified.

The ability to modify the length of the address information and/or the data key 120 allows for enhanced flexibility in how encryption keys are formed. For example, a data key's length can be customized to provide an encryption key of a target length. As another example, multiple data keys can be produced and combined (such as by application of a function) to form the encryption key. As yet another alternative, in implementations where data key(s) is (are) mixed with address information to form an encryption key, one or both of the lengths of the data key(s) and address information can be modified to allow for appropriate mixing to produce the encryption key.

The following are various implementations of modifying lengths of data key(s) and address information (scrambled or un-scrambled address information) that can be performed by the length modifier 130 and/or length modifier 132 and/or the mixer 124. In some implementations, the length of a data key 120 can be modified by simply adding bits or removing bits from the data key 120. For example, to increase the length of the data key 120, the data key 120 can be replicated and the replicated data keys (or some portions thereof) concatenated to form the encryption key.

In other implementations, modifying the length of a data key 120 can be accomplished by mixing, by the mixer 124, the data key 120 with address information.

In further implementations, multiple data keys 120 can be provided, and the multiple data keys 120 are combined, such as by application of a function. The applied function can include one or multiple of: (1) concatenating the multiple data keys 120 to form the encryption key; (2) multiplying the multiple data keys 120 to form the encryption key; (3) applying a hash function on the multiple data keys 120 to form the encryption key; (4) performing a lookup of a lookup table using the multiple data keys 120 to retrieve the encryption key; and (5) other functions. Note that application of the function on the multiple data keys 120 can either increase or decrease the length of a data key.

In further implementations, application of a function on multiple data keys 120 produces an output, which can then be mixed, by the mixer 124, with address information to form the encryption key.

Note that the length of address information can be modified by using any of the functions noted above for multiple data keys. For example, multiple pieces of address information can be produced, and any of the functions noted above can be applied to the multiple pieces of address information to produce an output used for deriving an encryption key, such as by mixing with data key(s) to produce the encryption key.

The encryption that is applied by the encryption module 116 can be one of various types of encryption. For example, a fast encryption technique can be an exclusive-OR (XOR) technique in which an encryption key is XOR-ed with write data. A benefit of using the XOR-based encryption technique is that it is relatively fast and can support relatively fast access speeds of the storage device 106 without adding delay to the write and read paths.

The encryption module 116 can thus apply the following exclusive-OR operation: A [symbol] K=C, where A represents the input plaintext data (write data) that is XOR-ed with the encryption key K (data key 120 or mixed key) to produce encrypted write data (C).

To perform decryption, the encrypted read data (C) can be XOR-ed with the encryption key K to recover the original plaintext (A), according to: C [symbol] K=A.

In alternative implementations, instead of using the XOR-based encryption technique, a higher-level encryption technique can be used. For example, the higher-level encryption can be Advanced Encryption Standard (AES) encryption. The AES encryption key is more difficult to hack than a key used in XOR encryption. However, AES encryption can come with increased circuit complexity (since more circuits have to be used to implement AES encryption), which can lead to increased access times or increased complexity in addressing the issue of increased access time involved in performing AES encryption. Other types of higher-level encryptions can be used in other examples.

In the key mixer 124, the address information that is mixed with the data key 120 can include one or a combination of the following: (1) at least a portion of an initial (un-scrambled) physical address provided by the storage device requestor 102, (2) at least a portion of a scrambled physical address, and (3) at least a portion of virtual address information (scrambled virtual address or un-scrambled virtual address). A “virtual address” refers to a logical address that is part of a virtual address space typically used by higher-level components of an electronic device, such as an operating system or a file system. The virtual address space is typically larger than the physical address space that defines the actual available storage locations in the storage device 106.

Each data key 120 stored in the key storage 122 can be a randomly generated key, which can be generated by the storage device controller 104 itself or by a component outside the storage device controller 104. For example, a data key can be generated by system boot code, such as basic input/output system (BIOS) code, which performs various initialization functions when an electronic device is first started. Alternatively, the data key can be generated by a management engine that is part of the chipset of an electronic device. As yet another alternative, the data key can be generated based on user input. As another example, the data key can be generated by a processor, a trusted platform module, or other component. The data key can also be received over a network connection or a management bus to which the electronic device is connected. Generally, the data key is generated without using data that can be discovered by reverse engineering a component in the electronic device.

Random data keys can be generated based on output of a random number generator. Also or alternatively, random data keys can be generated based on dates and/or time. To enhance security, the data key that is used to perform the encryption and decryption by the encryption module 116 and decryption module 118, respectively, changes with each system reset or reboot. Alternatively, a different data key can be generated when the electronic device resumes from a lower power state, such as a standby state, a hibernation state, or other lower power state. As yet a further alternative, encryption refresh cycles can be employed in which a new data key is generated in each new encryption refresh cycle.

The key storage 122 is a volatile storage device that loses its content upon loss or removal of power. For example, the key storage 122 can be a register in the storage device controller 104, or alternatively, the key storage 122 can be part of the storage device 106. The key storage 122 can be a write-only/write-once storage device (e.g., register) that is reset in response to a predefined event, such as the electronic device being shut down, being reset, entering into a lower power state, starting a new encryption refresh cycle, and so forth. A write-only storage means that the key storage 122 cannot be read by a component outside the storage device controller 104, and a write-once storage means that the key storage 122 can only be written once during each predefined interval (e.g., during the on time of an electronic device between resets, reboots, or power cycles; during a particular refresh cycle interval; and so forth).

As noted above, the storage device address 110 provided by the storage device controller 104 to access a location in the storage device 106 can be a scrambled address. Employing address scrambling allows for an additional layer of protection on top of the protection provided by the encrypting data stored in the storage device 106. As noted, the address scrambling can be performed by the address scrambler 126 in the storage device controller 104 in some examples. In alternative examples, instead of providing the address scrambler 126 in the storage device controller 104, the address scrambler 128 can be provided as part of the storage device requestor 102, or alternatively, the address scrambler 128 can be provided between the storage device requestor 102 and storage device controller 104 (in other words, the address scrambler can be provided in a component that is separate from the storage device requestor 102 and the storage device controller 104).

Scrambling an initial address can be performed using any one of various techniques. For example, address bits of the initial address can be switched around. Alternatively, an initial address can be scrambled by using a key, such as a randomly generated key. The key for scrambling the address can be a data key 120 (stored in the key storage 122) or a different key. The key can be mixed with or otherwise applied to the initial address to generate the scrambled address. Alternatively, address scrambling can be performed by hashing the initial address to produce a hash value that represents the scrambled address. As yet another alternative, a data structure, such as a table, can be stored to map input initial addresses to output addresses, where the output addresses are considered the scrambled addresses. Other techniques can be used in other implementations.

In implementations where a key is used to scramble an address, there can be various possible scenarios (some of which are set forth below). In a first scenario, the address scrambler 126 or 128 can scramble an initial physical address to form a scrambled address using a data key 120. The key mixer 124 mixes the initial physical address with the data key 120 to form a mixed key, and the mixed key can be used by the encryption module 116 and decryption module 118 to encrypt or decrypt data, respectively.

A second scenario involves the address scrambler 126 or 128 scrambling an initial physical address with an address key that is different from a data key 120. The initial physical address is mixed by the key mixer 124 with the data key 120 to form a mixed key that is used to encrypt or decrypt data.

In a third scenario, the address scrambler 126 or 128 can scramble an initial physical address using a different technique than a technique used for encrypting data. For example, a first encryption technique is used to scramble the initial physical address with a key (data key or address key different from the data key) to form the scrambled address, while a second encryption technique is used to encrypt write data with a data key (instead of a mixed key) to output encrypted write data.

In a fourth scenario, a scrambled address can be generated using an address key that is different from a data key. The scrambled address is mixed with the data key to form a mixed key to encrypt write data.

In a fifth scenario, a scrambled address can be generated using a data key. The scrambled address is mixed with the data key to form a mixed key to encrypt write data.

In a sixth scenario, a scrambled address can be generated using an encryption technique different from the encryption technique used for encrypting write data. In this scenario, a data key is used to encrypt the data, instead of a mixed key.

In a seventh scenario, an initial physical address can be scrambled to form a scrambled address, but a virtual address (or a scrambled virtual address) can be mixed with a data key to provide the mixed key for encrypting the write data. A variant of this scenario is to use the virtual address (or a scrambled virtual address) as the data key to encrypt write data.

There can be numerous other scenarios. Moreover, some scenarios can involve combinations of multiple ones of the above scenarios.

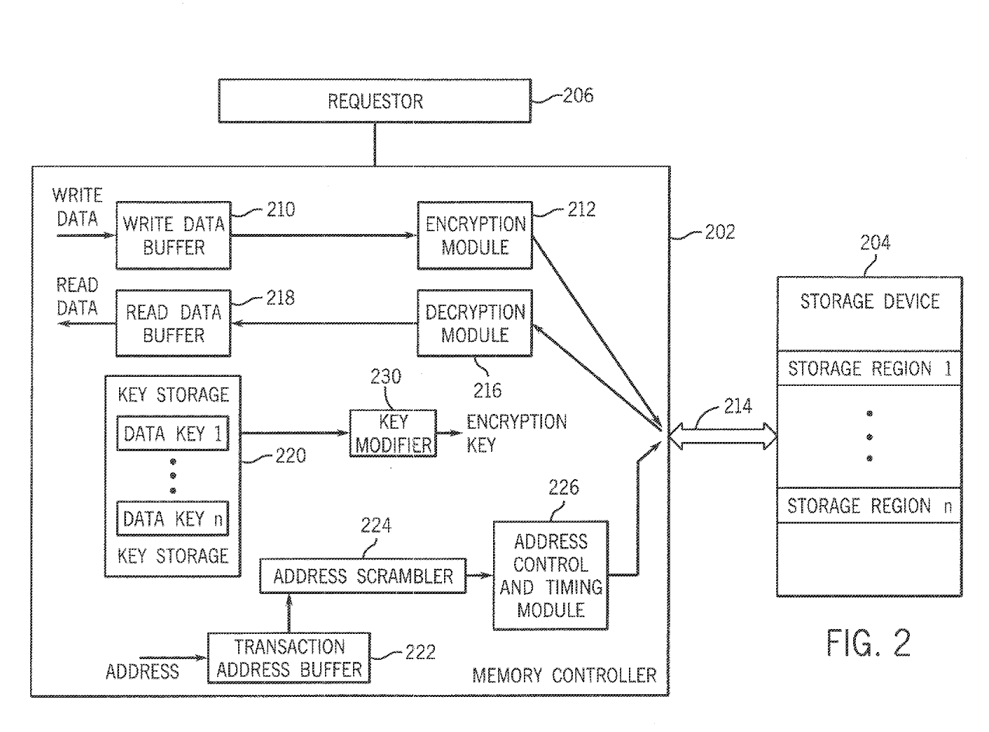

FIG. 2 shows another example arrangement that includes a memory controller 202 that is connected to a memory device 204 (note that in different examples, the memory controller 202 can be replaced with a storage device controller, while the memory device 204 is replaced with a storage device). The memory controller 202 implements memory protection mechanisms (similar to those noted above) to protect data to be stored in the memory device 204. The memory device 204 can represent a single device, or a combination of multiple devices (e.g., a single memory chip or multiple memory chips, or a single memory module or multiple memory modules).

The memory protection mechanisms implemented by the memory controller 202 include a data encryption mechanism to encrypt write data that is to be stored into the memory device 204. The memory protection mechanisms of the memory controller 202 can also include an address scrambler 224 to scramble an address that specifies a location in the memory device 204.

In the arrangement of FIG. 2, different memory regions of the memory device 204 can be protected using different protection techniques. As depicted in FIG. 2, the memory device has multiple memory regions (“memory region 1” . . . “memory region n”). The different memory regions can represent different portions of a particular memory device. The multiple memory regions can alternatively represent different memory devices. Thus, for example, in an electronic device having multiple memory devices, a first data key can be used to protect data in a first memory device, a second data key can be used to protect data in a second memory device, and so forth. The different keys can include multiple data keys (represented as “data key 1” . . . “data key n”, where n≧2) in a key storage 220.

In further examples, there can be different types of memory devices in the electronic device, in which case different data keys are used to protect data stored in the different types of memory devices. Thus, for example, a first data key is used to protect data in a first type of memory device (e.g., a DRAM-based memory device), a second data key is used to protect data in a second type of memory device (e.g., flash memory device), and so forth. Note also that there can be cache memory in the electronic device, such that another data key is used to protect the cache memory.

Additionally, note also that different data keys can be used for different memory regions depending on how the respective memory regions are used. For example, one of the memory regions can be an operating system (OS) area for storing data or instructions associated with an operating system. Another memory region can store data associated with a non-OS program, such as user or application data.

Alternatively, different data keys can be used during different modes of operation of the electronic device, where the different modes can refer to different levels of security, for example.

In other implementations, different levels of encryption can be applied to different memory regions. For example. XOR-based encryption can be applied for a first memory region, while AES encryption or some other higher-level encryption is applied for a different memory region.

In addition, in some implementations, different address scrambling can be used for different memory regions. For example, different keys (data keys or address keys different from the data keys) can be applied to generate different address scramblings. Alternatively, different encryption levels can be applied to provide different address scramblings for the different memory regions.

The different keys and/or different encryption levels and/or different address scramblings to be applied to different memory regions can be configured at build time of the electronic device or during electronic device operation by a user or administrator.

FIG. 2 further shows a requestor 206 (e.g., processor, I/O controller, etc.) coupled to the memory controller 202. The requestor 206 is able to issue read or write requests to the memory controller 202 to read or write data in the memory device 204.

For a write operation, as shown in FIG. 2, the memory controller 202 includes a write data buffer 210 to store incoming write data. An encryption module 212 applies encryption on the write data from the write data buffer 210, and provides the encrypted write data for storage at the memory device 204 over a memory bus 214. The memory bus 214 includes a control portion (having control signals), an address portion (containing an address), and data portion (containing data to be transferred between the memory controller 202 and the memory device 204).

For a read operation, read data is retrieved from the memory device 204 and provided to a decryption module 216. Note that the data read from the memory device 204 can be encrypted data, such that the decryption module 216 applies decryption to the encrypted read data to output decrypted read data to a read data buffer 218, where the read data can be provided to the requestor 206.

The memory controller 202 also includes a transaction address buffer 222 to store an address associated with a particular transaction (read transaction or write transaction). The address scrambler 224 applies address scrambling on the address from the transaction address buffer 222. The scrambled address is provided from the address scrambler 224 to an address control and timing module 226, which outputs the scrambled address over the address portion of the memory bus 214.

As further depicted in FIG. 2, the memory controller 202 includes a key modifier 230 that can cause a length of an element used to form an encryption key to be modified, similar to the mechanisms discussed above in connection with FIG. 1. The key modifier 230 can modify the length of a data key (from the key storage 220), and/or modify the length of address information (un-scrambled or scrambled), and/or mix a data key with address information (un-scrambled or scrambled). Effectively, the key modifier 230 of FIG. 2 can be any one or combination of the length modifier 130, length modifier 132, and mixer 124 of FIG. 1.

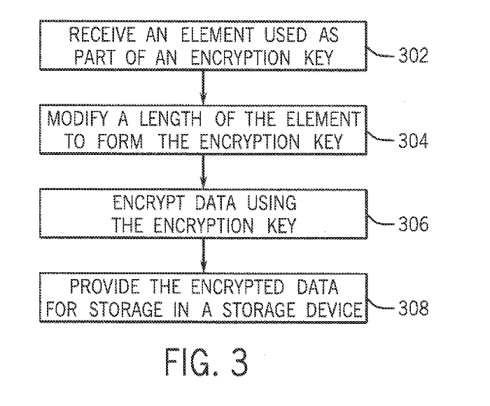

FIG. 3 is a flow diagram of a process performed by a control system. As used here, the control system (or equivalently, “control subsystem”) includes processing circuitry that is capable of performing predefined tasks. For example, the control system can include one or a combination of any of the following: the storage device requestor 102 of FIG. 1, storage device controller 104 of FIG. 1, requestor 206 of FIG. 2, and memory controller 202 of FIG. 2.

The control system receives (at 302) an element used as part of an encryption key for encrypting data to be stored in a storage device (e.g., 106 in FIG. 1 or 204 in FIG. 2). The element can be a data key(s) and/or address information. A length of the element is modified (at 304) to form the encryption key. This modification can be performed by any one or combination of the following: length modifier 130, length modifier 132, mixer 124, and key modifier 230.

The control system next encrypts (at 306) write data using the encryption key. The encrypted data is then provided (at 308) for storing in the storage device.

The control system used to implement the process of FIG. 3 can be implemented with hardware only, or a combination of hardware and machine-readable instructions that are loaded for execution on processing circuitry (which can be part of the requestor 102 or 206 or part of the storage device controller 104 or memory controller 202 in FIG. 1 or 2). Processing circuitry can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

1. A method comprising:
receiving, by a control system, an element used as part of an encryption key for encrypting data;
modifying, by the control system, a length of the element to form the encryption key;
encrypting, by the control system, data using the encryption key; and
providing, by the control system, the encrypted data for storage in a storage device.

2. The method of claim 1, wherein receiving the element comprises receiving a data key, and wherein modifying the length of the data key comprises adding bits to or removing bits from the data key.

3. The method of claim 2, wherein modifying the length of the data key comprises combining the data key with address information to form the encryption key.

4. The method of claim 3, wherein combining the data key with the address information comprises combining the data key with one of (1) at least a portion of a physical address specifying a location of the storage device, and (2) at least a portion of a virtual address for accessing content of the storage device.

5. The method of claim 2, wherein the data key is a first data key, the method further comprising:
generating at least another data key: and
applying a function on the first data, key and the at least another data key to form the encryption key.

6. The method of claim 5, wherein applying the function comprises at least one selected from:
concatenating the first data key and the at least another data key;
multiplying the first data key with the at least another data key;
applying a hash function to the first data key and the at least another data key;
using a lookup table based on the first data key and the at least another data key.

7. The method of claim 5, wherein applying the function on the first data key and the at least another data key produces an output, the method further comprising combining the output of the function with address information to form the encryption key.

8. The method of claim 1, wherein modifying the length of the element comprises applying a modification algorithm on the element to generate the encryption key.

9. The method of claim 1, wherein receiving the element comprises receiving a data key, wherein modifying the length of the element comprises combining the data key with address information, and wherein the address information has a different length than the data key, the method further comprising:
modifying a length of the address information; and
wherein combining the data key with the address information comprises combining the data key with the modified address information.

10. The method of claim 1, wherein receiving the element comprises receiving a data key, wherein modifying the length of the element comprises combining the data key with address information, and wherein the address information is based on at least a part of a physical address or at least a part of a virtual address.

11. The method of claim 10, wherein a length of the data key is different from a length of the address information, the method further comprising:
changing a length of the data key; and
wherein combining the data key with the address information comprises combining the data key with the changed length with the address information.

12. The method of claim 10, wherein the address information is based on applying a function on at least the part of a physical address or at least the part of a virtual address, wherein the function includes a hash function, a table lookup, and a multiplication function.

13. (canceled)

14. A system comprising:
at least one storage device; and
a control subsystem to:
receive at least one data key;
produce an encryption key based on the at least one data key, wherein the production of the encryption key involves modifying a length of an element used to form the encryption key: and
encrypt data to be stored in the at least one storage device using, the encryption key.

15. The system of claim 14, wherein the element comprises one or both of the at least one data key and address information to be mixed with the at least one data key.
